(19) United States
(12) Patent Application Publication
(10) Pub. No.: US 2003/0061556 A1
(43) Pub. Date: Mar. 27, 2003

(54) Semiconductor device and its design method

(75) Inventor: Hitoshi Watanabe, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/101,391

(22) Filed: Mar. 20, 2002

(30) Foreign Application Priority Data
Sep. 27, 2001 (JP) 2001-298532

(51) Int. Cl. G06F 11/00

(52) U.S. Cl. 714/739

(57) ABSTRACT

A design method of a semiconductor device that performs self-diagnosis by comparing an expected value with a signal that is obtained by applying a random pattern to a logic circuit to be tested, and by compressing an output of the logic circuit, wherein each bit of all or part of bits that make up the expected value is provided with one of a first cell that outputs an input signal A and a second cell that outputs an input signal B, corresponding to the expected value, thereby semiconductor design efficiency is enhanced.

### BACKGROUND OF THE INVENTION

1. Field of the Invention

The present invention generally relates to a semiconductor device and testing method thereof, and specifically relates to a technology of self-diagnostics of the semiconductor device.

2. Description of the Related Art

BIST (Built In Self Test) has been known as a testing method of a semiconductor device, which is a testing method wherein a semiconductor device itself performs self-diagnosis. In order to realize BIST, a random number generator, a compressor, and an expected-value generation circuit are installed in the semiconductor device.

As test data, a random pattern generated by the random number generator is supplied to a plurality of scanning chains of a user logic (for example, PLA: Programmable Logic Array), which is a logic circuit to be tested such that all the circuit elements in the user logic (for example, flip-flop) are tested. A flip-flop latches the test data synchronously with a test clock supplied. Data output through the scanning chains are compressed by the compressor. The compressed data are compared with an expected value generated by the expected-value generating circuit. A comparison result is output as a test result.

Thus, the obtained compressed data serve as a pattern unique to a circuit configuration of the user logic. Therefore, the user logic is verifiable by comparing the obtained compressed data with the expected value. Then, the circuit configuration of the user logic is modified if needed.

The BIST is disclosed by Japanese Patent 1-277779, for example.

Change of the circuit configuration of the user logic also changes the expected value. That is, a circuit configuration of the expected-value generating circuit has to be changed such that an expected value corresponding to the user logic after the user logic is changed can be generated. {Conventionally, the change in the expected-value generating circuit is implemented by re-wiring, which is time consuming and, therefore, expensive.} It is desired that test efficiency is improved by facilitating the change of the expected-value generating circuit.

Therefore, the present invention aims at raising the test efficiency, hence the design efficiency, solving the above problem of the conventional technology by facilitating a change of the expected-value generating circuit.

### SUMMARY OF THE INVENTION

It is a general object of the present invention to provide a semiconductor device and a design method that substantially obviate one or more of the problems caused by the limitations and disadvantages of the related art.

Features and advantages of the present invention will be set forth in the description that follows, and in part will become apparent from the description and the accompanying drawings, or may be learned by practice of the invention according to the teachings provided in the description. Objects as well as other features and advantages of the present invention will be realized and attained by a semiconductor device and a design method particularly pointed out in the specification in such full, clear, concise, and exact terms as to enable a person having ordinary skill in the art to practice the invention.

To achieve these and other advantages and in accordance with the purpose of the invention, as embodied and broadly described herein, the invention provides a semiconductor device that includes an expected value generating circuit, change of which is facilitated, and a design method of the semiconductor device.

The design method includes testing a semiconductor device, wherein a random pattern is supplied to a logic circuit to be tested, output from the logic circuit is compressed, and the compressed data are compared with an expected value generated by an expected-value generating circuit. Here, one of a first cell that outputs an input A and a second cell that outputs an input B is provided, according to the expected value, to each of all or part of bits that make up the expected value.

When the expected value should be changed, a cell corresponding to a bit to be changed is replaced. If a cell that presently has a first cell is to be changed, the cell is replaced with a second cell, and vice versa. In this manner, re-wiring processing that is conventionally required is no longer necessary. Therefore, the present invention enhances design efficiency, with the expected-value generating circuit being changed easily in a short period time.

In a semiconductor device, wherein a random pattern is supplied to a logic circuit to be tested, output from the logic circuit is compressed, and the compressed data are compared with an expected value generated by an expected-value generating circuit, the expected-value generation circuit of the present invention provides one of a cell that outputs an input A and a cell that outputs an input B to each bit of all or part of bits that make up the expected value, according to the expected value.

Alternatively, in a semiconductor device, wherein a random pattern is supplied to a logic circuit to be tested, output from the logic circuit is compressed, and the compressed data are compared with an expected value generated by an expected-value generating circuit, the expected-value generation circuit of the present invention provides both of a cell that outputs an input A and a cell that outputs an input B to each bit of all or part of bits that make up the expected value.

### BRIEF DESCRIPTION OF THE DRAWINGS

FIG. 1 is a block diagram showing a configuration of a semiconductor device of the embodiment of the present invention;

FIG. 2 is a block diagram showing a configuration example of a compressor shown in FIG. 1;

FIG. 3 is a block diagram showing a configuration example of a conventional expected-value generation circuit;

FIG. 4(A) shows a configuration of a cell that outputs an input A and a cell that outputs an input B;

FIG. 4(B) shows an example of how the configuration in FIG. 4(A) is implemented;

FIG. 4(C) shows how connections are made in the expected-value generating circuit;

FIG. 4(D) shows an example of how the connections in FIG. 4(C) are implemented;

FIG. 5(A) is a flowchart of a semiconductor device design method of the present invention; and

FIG. 5(B) is a flowchart of a semiconductor device design method of a conventional technology.

### DESCRIPTION OF THE PREFERRED EMBODIMENTS

In the following, embodiments of the present invention will be described with reference to the accompanying drawings.

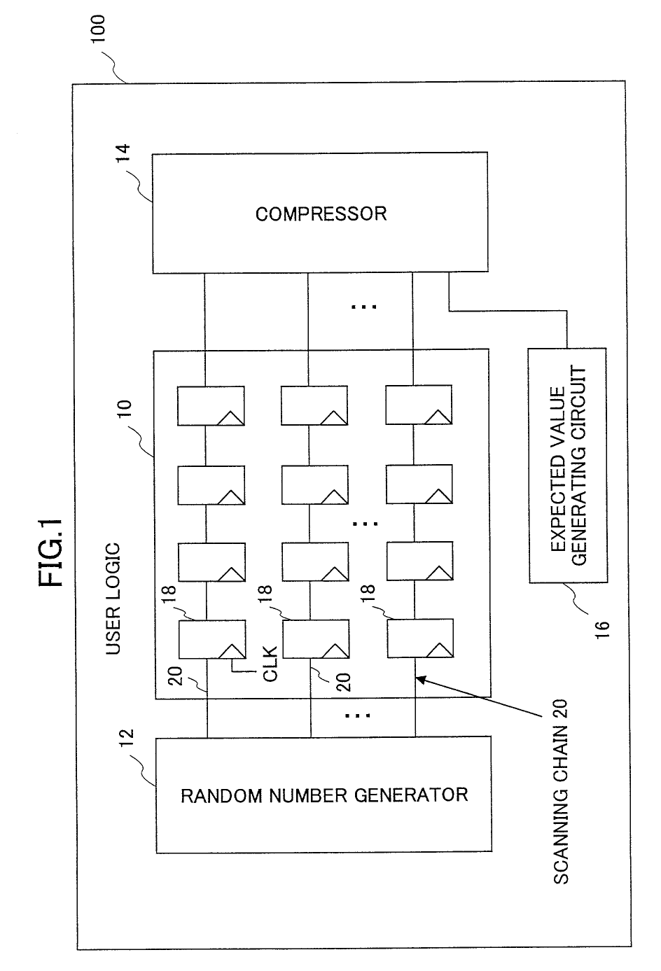

FIG. 1 is a block diagram of a semiconductor device 100 that includes a self-diagnosing function by BIST.

The semiconductor device 100 includes a logic circuit 10 that is a testing target, a random number generator 12, a compressor 14, and an expected-value generation circuit 16. A random pattern generated by the random number generator 12 is provided to the logic circuit 10, which is the testing target. Data output from the logic circuit 10 are compressed by the compressor 14. Then, the compressed data are compared with an expected-value generated by the expected-value generating circuit 16. Thus, the semiconductor device 100 has a function of comparing the compressed data output with the expected value. Here, a block that shows the semiconductor device 100 is equivalent to a semiconductor chip.

The logic circuit 10 is the testing target, and is a functional unit by itself. The logic circuit 10 is structured by, e.g., a PLA that is a logic circuit programmed according to a user's specification. The logic circuit 10 has n scanning chains 20 (n is an arbitrary integer). Each of the scanning chains 20 includes a plurality of circuit elements 18 that are cascade-connected. Each of the circuit elements 18 is a logical element, such as a flip-flop. In the following explanation, each of the circuit elements 18 is explained as a flip-flop. To a clock terminal of each of flip-flops 18, a test clock CLK is supplied. The test clock may be a clock supplied from an external source, for example, when testing. The test clock may be a clock generated by an internal timing generator of the semiconductor device 100.

The random number generator 12 is connected on an input side of the scanning chain 20. The random number generator 12 generates a random pattern. Each of the flip-flops 18 latches the random pattern input synchronously with the test clock, and outputs to a flip-flop 18 of the next stage. Thus, the data finally obtained through all the flip-flops 18 of the scanning chain 20 is output to the compressor 14. The compressor 14 compares the data received from the logic circuit 10 with the expected value generated by the expected-value generating circuit 16.

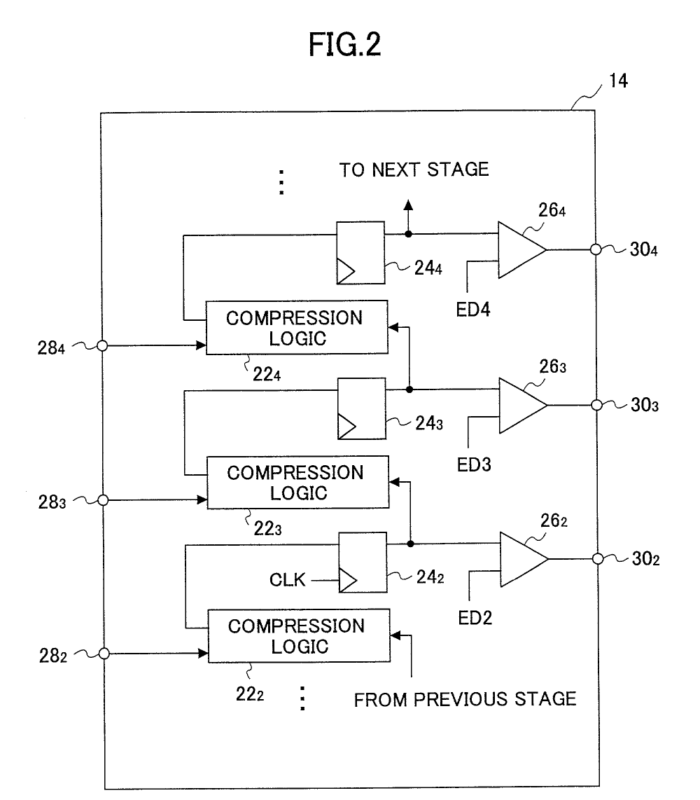

FIG. 2 is a block diagram showing a configuration example of the compressor 14. The compressor 14 has n input terminals 28₁ through 28ₙ corresponding to the n scanning chains 20. In FIG. 2, only three input terminals 28₂, 28₃, and 28₄ are shown for convenience. Each of the input terminals 28₁ through 28n is connected to an input terminal of each of compression logic units 22₁ through 22ₙ. In FIG. 2, only three compression logic units 22₂, 22₃, and 22₄ are shown for convenience. Each of the compression logic units 22₁ through 22ₙ is connected to the compression logic of a preceding stage via flip-flops 24₁-24ₙ. In FIG. 2, only three flip-flops 24₂, 24₃, and 24₄ are shown for convenience. For example, the compression logic 22₃ is connected with the compression logic 22₂ of the preceding stage through the flip-flop 24₂, and is connected to the latter compression logic 22₄ through the flip-flop 24₃.

Each of the compression logic units 22₁-22ₙ compresses data from a corresponding scanning chain 20 and data output from a compression logic 22 of a preceding stage (hereafter, a reference sign without a suffix means one of the corresponding units, for example, a compression logic unit 22 means one of the compression logic units 22₁-22ₙ), using a predetermined logic, outputs to a flip-flop 24 located at an output stage. Each of the flip-flops 24₁-24ₙ outputs and inputs data synchronously with the test clock CLK.

Output of each of the flip-flops 24₁-24ₙ is connected to an input terminal of each of comparators 26₁-26ₙ, respectively, while connected with an input of the compression logic 22 of the next stage. In FIG. 2, only three comparators 26₂, 26₃, and 26₄ are shown for convenience. Another input terminal of each of the comparators 26₁-26ₙ inputs data ED₁-EDₙ, respectively, which are expected values generated by the expected-value generation circuit 16. In FIG. 2, only three expected-values ED₂, ED₃, and ED₄ are shown for convenience. For example, a comparator 26₂ compares the expected-value ED2 with the output data of the flip-flop 24₂. Comparison results of the comparators 26₁-26ₙ are output through output terminals 30₁-30ₙ, respectively. Although these output terminals 30₁-30ₙ are output terminals of the compressor 14, the output terminals 30₁-30ₙ may be made terminals of the semiconductor device 100, serving an external connection.

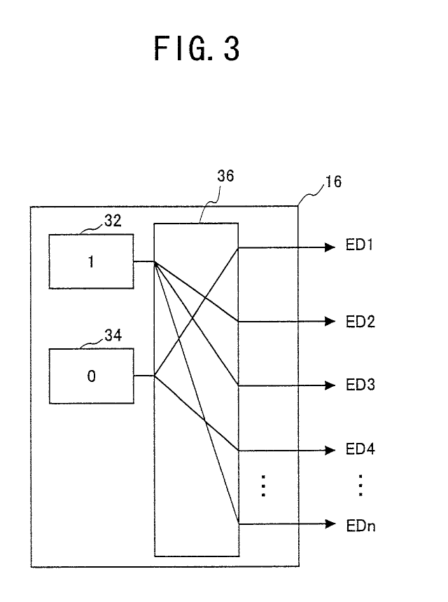

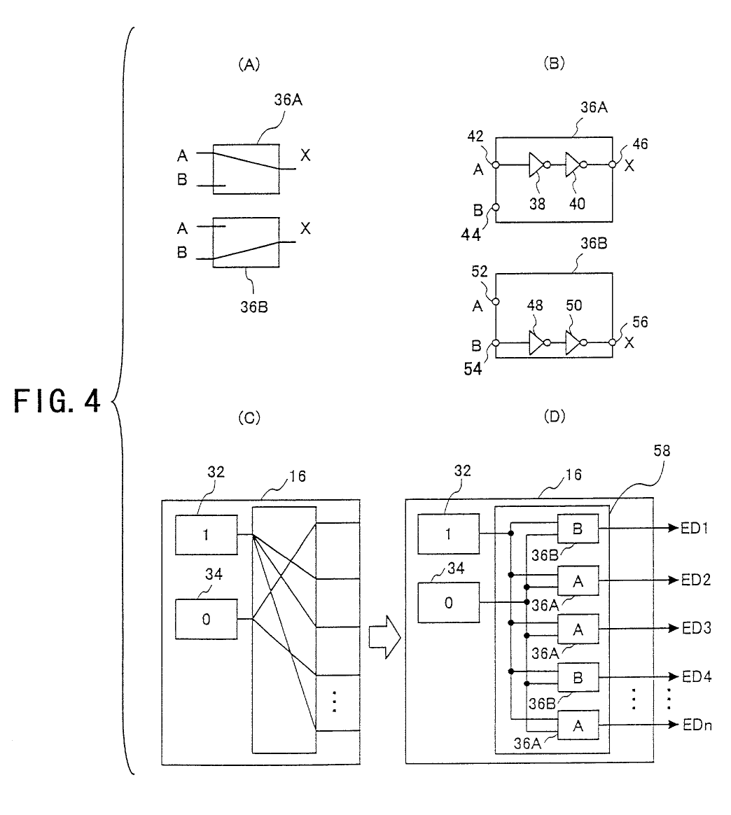

FIG. 3 shows a configuration example of a conventional expected-value generation circuit 16. The configuration example of FIG. 3 belongs to a technology related to the present invention, and illustrates a preceding technology. An expected-value generation circuit 16 of the present invention is shown in FIG. 4, and described later.

The conventional configuration shown in FIG. 3 includes a “1” generator 32, a “0” generator 34, and a wiring section 36. The “1” generator 32 generates a bit “1.” The “0” generator 34 generates a bit “0.” The wiring section 36 includes wire-connections which set one of a bit “1” and a bit “0” to each of expected values ED1-EDn. In the example, the wiring section 36 connects the “1” generator 32 such that the expected-values ED2, ED3, and EDn carry “1”, and connects the “0” generator 34 such that the expected values ED1 and ED4 carry “0”. Here in FIG. 3, only the expected values ED1-ED4 and EDn are shown for convenience. Thus, the generated expected values ED1-EDn are output to corresponding comparators 26₁-26ₙ, respectively, as shown in FIG. 2.

If the logic circuit 10 is changed, it is necessary also to change the expected values ED1-EDn. In order to change the expected values, re-wiring of the wiring section 36 is required. For example, in order to change the expected values ED2 and ED3 to “0” from “1”, it is necessary to remove present wiring to the “1” generator 32, and to prepare new wiring to the “0” generator 34. It is necessary to ensure that electrical properties, such as delay, do not change in the re-wiring.

FIG. 4(C) and FIG. 4(D) show an example of an expected-value generation circuit 16 that avoids a complicated process of the re-wiring, which is mentioned above. Connections of the expected-value generation circuit 16 showed in FIG. 4(C) are implemented by a circuit configuration shown in FIG. 4(D). The expected-value generation circuit 16 shown in FIG. 4(D) includes a “1” generator 32, a “0”; generator 34, and a selection circuit 58. In the selection circuit 58, one of two cells 36A and 36B is provided to each of the expected values ED1-EDn. Each cell, being one of 36A and 36B, is connected to both the “1” generator 32 and the “0” generator 34.

FIG. 4(A) shows a configuration of the cells 36A and 36B. The cell A receives signals A and B and outputs the signal A as an output X. The cell B receives the signals A and B and outputs the signal B as an output X. Here, the signals A and B are equivalent to the data “1” generated by the “1” generator 32 of FIG. 4(D) and the “0” generated by the “0” generator 34 of FIG. 4(D), respectively.

Therefore, in FIG. 4(D), the expected values ED2, ED3, and EDn are the same as the signal A (for example, “1”), and the expected values ED1 and ED4 are the same as the signal B (for example,

The cells 36A and 36B are in the same dimensions and have the same capacity (capacitance). An example of circuit configuration of the cells 36A and 36B is shown in FIG. 4(B). The cell 36A has input terminals 42 and 44, an output terminal 46, and two buffers 38 and 40. The two buffers 38 and 40 are connected in series between the input terminal 42 and the output terminal 46. The input terminal 44 is open. When the signals A and B are received at the input terminals 42 and 44, respectively, the signal A is output as an output X from the output terminal 46.

The cell 36B has input terminals 52 and 54, and an output terminal 56, and two buffers 48 and 50. The two buffers 48 and 50 are connected in series between the input terminal 54 and the output terminal 56. The input terminal 52 is open. When the signals A and B are received at the input terminals 52 and 54, respectively, the signal B is output as an output X from the output terminal 56.

The buffers 38, 40, 48, and 50 are in the same dimensions and have the same circuit configuration. Further, wire length between the input terminal 42 and the output terminal 46, and wire length between the input terminal 54 and the output terminal 56 are the same. That is, the cells 36A and 36B have the same dimensions and the same capacity (capacitance).

Therefore, when the expected value is changed, cells 36A and 36B of the selection circuit 58 of FIG. 4(D) are replaced as required, causing no change in electrical properties, such as delay. For example, if the expected value data ED2 of FIG. 4(D) is to be changed from “1” to “0”, the cell 36A is replaced by a cell 36B. Therefore, the necessity of performing complicated re-wiring as described with reference to FIG. 3 is dispensed with, and in this manner, change of the expected-value generating circuit 16, i.e., change of an expected value, can be made easily in a short period of time.

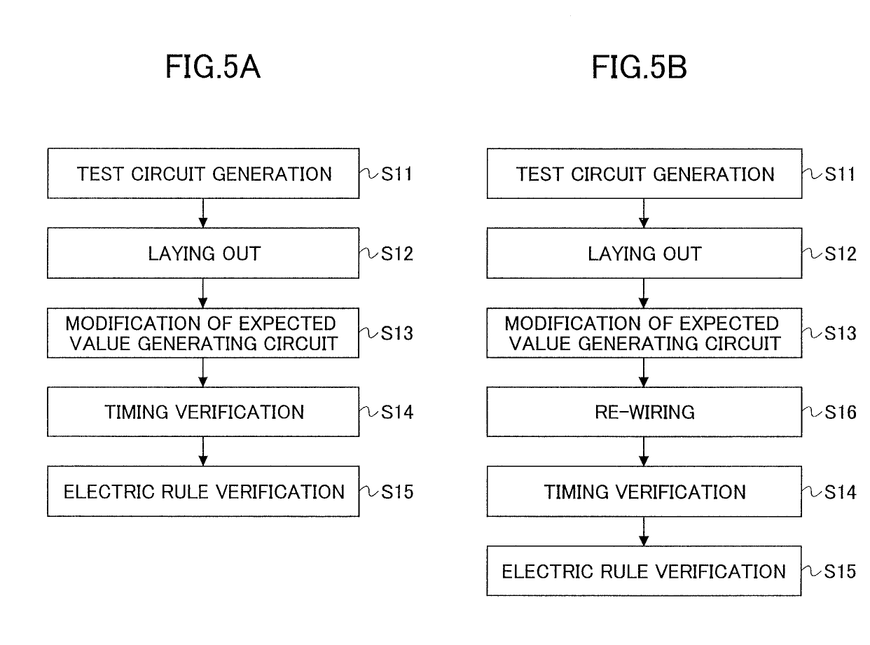

FIG. 5(A) is a flowchart that shows a design method of a semiconductor device of an embodiment of the present invention. FIG. 5(B) is a flowchart of a conventional design method of a semiconductor device. Specifically, FIG. 5(A) shows the design method using the expected-value generation circuit 16 showed in FIG. 4, and FIG. 5(B) shows the design method using the expected-value generation circuit 16 showed in FIG. 3.

At step S11, the random number generator 12 and the expected-value generation circuit 16 are designed to the logic circuit 10, all of which are shown in FIG. 1. This design process sets up such that data obtained by supplying a random pattern generated by the random number generator 12 to the logic circuit 10, which is an internal circuit to be tested, is first compressed by the compressor 14, and then, the compressed data are compared with the expected value generated by the expected-value generation circuit 16.

Here, a system design is assumed to have been performed prior to step S11. The system design includes a function design, a function description, function verification, logic synthesis, logic verification, and so on.

Step S12 is a layout verification process in which the layout of each circuit included in the semiconductor device 100 shown in FIG. 1 is verified. In this process, the layout of the scanning chain 20 of the logic circuit 10 is also verified, and a layout change of changing an arrangement of the flip-flops 18 in the scanning chain 20 is made if needed.

Step S13 is a correction process of the expected-value generation circuit 16. If the logic circuit 10 and particularly the scan chain 20 are changed, it is also necessary to change the expected value of the expected-value generation circuit 16. Change of expected value is performed by identifying one or more bits of the expected values ED0-EDn, which should be changed, and replacing corresponding cells with another type from the present type. The expected value is changed by this cell replacement process simply and certainly, without changing circuit properties.

On the other hand, in the conventional process of FIG. 5(B), after identifying one or more bits of the expected values ED0-EDn that should be changed at step S13, a complicated re-wiring process should take place at step S16. By the design method of FIG. 5(A) according to the present invention, the re-wiring process of step S16 is unnecessary.

Step S14, following step S13 of FIG. 5(A) and following step S16 of FIG. 5(B), is timing verification processing. Step S14 verifies whether the logic circuit 10 operates at suitable timing. For example, a circuit simulation is used for this verification.

After step S14, an electric rule verification process is performed at step S15. Extraction of a parasitic element and the like are performed from a mask figure, and whether the circuit realized by the mask figure fulfills a desired electrical property is checked. This check is not performed on the entire semiconductor device 100, but critical circuit portions are checked.

The semiconductor device 100 is manufactured through a design procedure such as above. The flowchart shown in FIG. 5(A) can be called a part of the manufacturing method of the semiconductor device 100 according to the present invention. Since the semiconductor device 100 manufactured through such a procedure can cut down the cost and time concerning testing, it is advantageous in cost.

As explained above, according to this invention, design efficiency can be raised because an expected-value generating circuit can be changed easily in a short period of time.

Further, the present invention is not limited to these embodiments, but various variations and modifications may be made without departing from the scope of the present invention.

The present application is based on Japanese priority application No. 2001-298532 filed on Sep. 27, 2001 with the Japanese Patent Office, the entire contents of which are hereby incorporated by reference.

What is claimed is:

1. A semiconductor device, wherein a random pattern is applied to a logic circuit to be tested, and output data thereof are compressed and compared with an expected value generated by an expected-value generating circuit, the expected-value generating circuit, comprising one of a first cell that outputs a first input signal A and a second cell that outputs a second input signal B, the cell being provided to each bit of all or a part of bits that make up the expected value, a selection between the first cell and the second cell being in accordance with the expected value.

2. A semiconductor device, wherein a random pattern is applied to a logic circuit to be tested, and output data thereof are compressed and compared with an expected value generated by an expected-value generating circuit, the expected-value generating circuit comprising a first cell that outputs a first input signal A, and a second cell that output a second input signal B, the first cell and the second cell being provided to each bit of all or a part of bits that make up the expected value.

3. The semiconductor device as claimed in claim 1, wherein each cell has one common capacitance and common dimensions.

4. The semiconductor device as claimed in claim 2, wherein each cell has one common capacitance and common dimensions.

5. The semiconductor device as claimed in claim 1, wherein the first cell is connected to a first circuit that generates the first input signal A, and the second cell is connected to a second circuit that generates the second input signal B.

6. The semiconductor device as claimed in claim 2, wherein the first cell is connected to a first circuit that generates the first input signal A, and the second cell is connected to a second circuit that generates the second input signal B.

7. A design method of a semiconductor device, wherein a random pattern is applied to a semiconductor circuit to be tested, and output data thereof are compressed and compared with an expected value, comprising an expected-value generating step, wherein one of a first cell that outputs a first input signal A and a second cell that outputs a second input signal B is provided to each bit of all or a part of bits that make up the expected value, in accordance with the expected value, and the expected value is formed by output from the front and the second cells.

8. The design method of the semiconductor device as claimed in claim 7, wherein change of the expected value is performed by replacing a cell corresponding to a bit to be changed from the first cell to the second cell if a present cell is the first cell, and from the second cell to the first cell if the present cell is the second cell.

9. A manufacturing method of a semiconductor device that comprises a step of a random pattern being applied to a logic circuit to be tested, and output data thereof being compressed and compared with an expected value, further comprising a step of generating the expected value by providing each bit of all or part of bits that make up the expected value with one of a first cell that outputs a first input signal A and a second cell that outputs a second input signal B, according to the expected value, and forming the expected value by outputs of the first and the second cells.
